(19) United States
(12) Patent Application Publication
(10) Pub. No.: US 2020/0191411 A1
(43) Pub. Date: Jun. 18, 2020

(54) CONVECTION FAN COVER

(71) Applicants: BSH Home Appliances Corporation, Irvine, CA (US); BSH Hausgeräte GmbH, Munich (DE)

(72) Inventor: Robert Colehour, Knoxville, TN (US)

(21) Appl. No.: 16/221,646

(22) Filed: Dec. 17, 2018

(51) Int. Cl. F24C 15/32

(52) U.S. Cl. CPC F24C 15/322; A21B 1/24

(57) ABSTRACT

An improved convection fan cover is provided. In one or more implementations, the improved convection fan cover has a rotating blocker that is geared off of the fan shaft of a convection heating system. As the convection heating system operates, the rotating blocker causes an oscillation effect that alters the flow of air throughout an oven cavity, contributing to a more even cooking profile.

### FIELD OF TECHNOLOGY

The present technology relates to improvements for fans in home appliances, in particular, for convection fans in cooking appliances (e.g., microwaves, ranges, ovens, etc.).

### BACKGROUND

Traditional convection ovens use a fan to circulate air inside the oven cavity. To protect the internals of the convection fan, a fan cover can be used.

However, these fan covers are typically simple and have no function other than protecting the convection fan.

Accordingly, what is needed is a way to increase the functionality of a convection fan cover while increasing the benefits a convection fan provides.

### BRIEF SUMMARY

The present invention is directed to an improved convection fan cover. These improvements include increased functionality and performance for a convection cooking system.

Used in conjunction with a convection heating system having a heating element for heating air and a fan to blow heated air into the cooking cavity of an oven, the convection fan cover has a series of openings to allow heated air to be blown into the cooking cavity while providing protection for the components of the convection heating system.

The convection fan cover also has an oscillation system that operates in conjunction with the convection heating system. The oscillation system uses a blocking member that rotates around the center line axis of the convection fan cover to block openings in the fan cover. As it rotates, the blocking member traces a path along the inner surface of the fan cover, effectively following the circumference of the fan cover. Opposite the blocking member is a counter weight/counter balance that can be further utilized as a second blocking member.

The oscillation system is powered by the convection fan itself. Translating motion of the fan to the blocking member is the axle aligned along the center line axis. The axle is geared to the fan shaft, and provides motive energy to the oscillation system.

These improvements allow for a convection fan cover that provides the protective benefits of traditional fan covers while increasing the functionality and performance for a convection cooking system.

Various other objects, features, aspects, and advantages of the present invention will become more apparent to those skilled in the art upon review of the following detailed description of preferred embodiments of the invention and accompanying drawings in which like numerals represent like components.

### BRIEF DESCRIPTION OF THE DRAWINGS

FIG. 1 is a perspective, external view of a convection oven.

FIG. 2 is a perspective view of the oven cavity of a convection cavity

FIG. 3 is a perspective view of an improved convection fan cover.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Throughout this disclosure, the terms top, bottom, front, back, left and right may be used. These terms are only intended to provide relational orientation with respect to one another. For example, any two opposed sides can be a right side and a left side and by changing to an opposed viewpoint, right versus left will be changed. Thus, top, bottom, front, back, left and right should not be considered limiting and are used only to distinguish their relationship to one another.

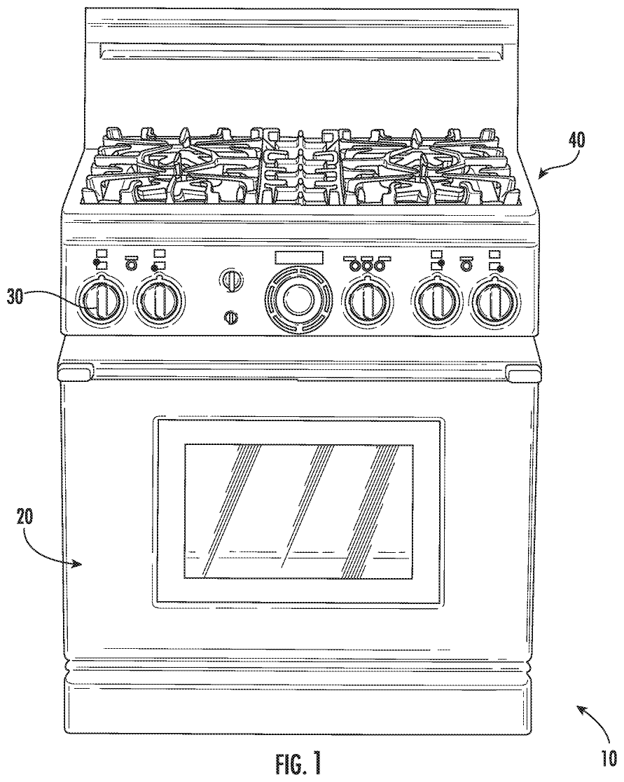

FIG. 1 depicts a standard convection range having both a cooktop and an oven. The range (10) has an oven door (20) that opens to access an oven cavity where foodstuffs can be inserted and cooked. The oven has a standard control system (30) for manipulating the cooking systems. As depicted, the cooktop (40) has a series of gas burners. While the depicted range has an oven cavity and cooktop that uses provides heat via gas (e.g., propane or other natural gas) alternative embodiments may have heating elements powered by electricity or other means.

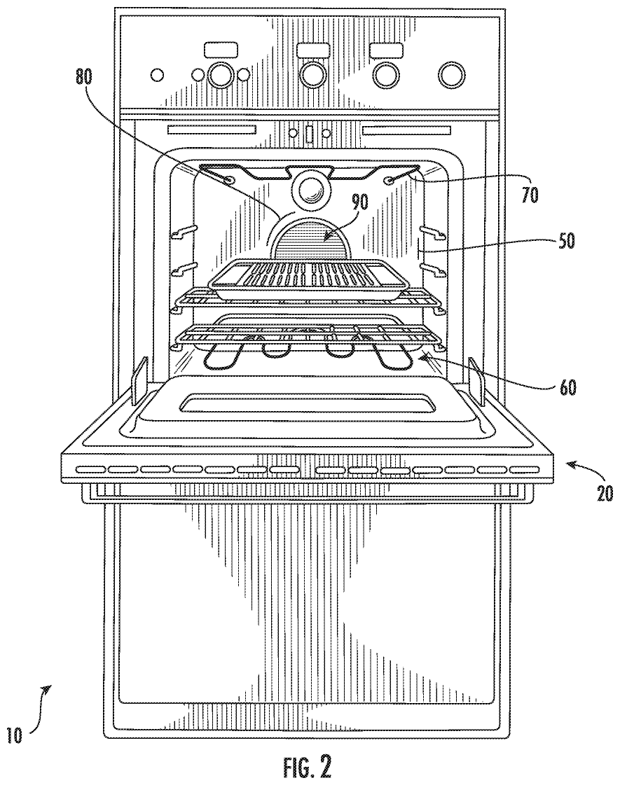

FIG. 2 depicts the oven cavity (50) of a standard convection range. The standard convection range has a bottom burner (60), a top/broil burner (70), and a convection heating system (80) disposed along the rear wall of the oven cavity. The convection heating system is located adjacent to an opening in the rear wall, behind or through which is positioned the fan of the convection heating system. The fan and/or opening in the rear wall is covered by a traditional convection fan cover (90).

The convection heating system is traditionally mounted to the oven body, and has a heating element (either gas or electric) for heating air pulled into the convection heating system from a source (typically fresh air from outside the oven body, or previously heated air from inside the oven cavity), and a fan to blow the heated air into the oven cavity through the opening in the rear wall of the oven cavity.

The purpose of the traditional convection fan cover is to protect the fan blades and internals of the convection heating system from coming into contact with contents placed in the oven cavity. Additionally, the traditional convection fan cover has several slots that allow air-flow to pass from the convection fan system into the oven cavity to cook foodstuffs placed within the cavity.

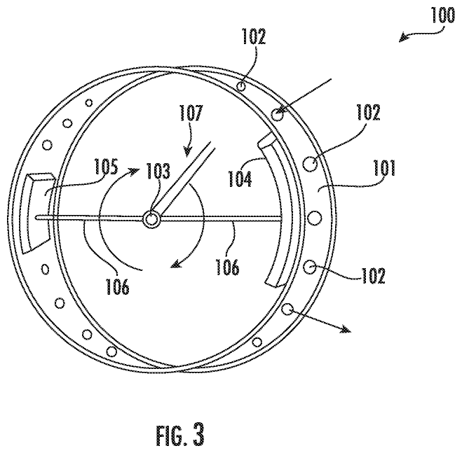

Currently, traditional convection fan covers have fixed inlets and outlets for directing air flow in a static manner. In contrast, FIG. 3 illustrates an improved convection fan cover (100) in accordance with embodiments of this invention that provides the benefits of traditional convection fan covers while allowing air outlets to be blocked and opened, resulting in a dynamic air flow in the oven cavity.

The improved convection fan cover (100) depicted in FIG. 3 has a plurality of vents to allow air to flow through the improved cover, and a rotating member that periodically blocks vents during operation of the convection heating system. As a result, this improved convection fan cover creates a rotating airflow direction system which can result in a more even cooking profile for foods cooked in the oven cavity.

The improved convection fan cover has a housing (101) with a cylindrical shape, the housing having both an inner and outer wall, and a top cover (not depicted). Around the circumference of the housing are located several openings or vents (102) to allow air from the convection heating system to pass through the improved convection fan cover into the oven cavity. While in the preferred embodiment the top cover is solid and does not allow for the passage of air, alternative embodiments can allow for some degree of air flow to create different air flow profiles in the oven cavity.

Being in the shape of a cylinder, the housing (101) has a determinable center line axis (103) and height.

Disposed inside the housing (101) is an oscillation system that alters the air flow through the improved convection fan cover. Extending from the center line axis (103) are two arms (106), the two arms terminating at an internal blocker (104) and a counterbalance (105) directly opposite the internal blocker. The internal blocker and counterbalance are preferably flush, or nearly flush with the inner wall of the housing.

The axle (107) extends along the center line axis (103) towards the convection heating system and is mechanically coupled to the fan of the convection heating system. As the convection heating system operates, movement of the convection heating fan results in movement of the axle causing the two arms (106) of the improved convection fan cover to rotate while the convection heating system is in operation.

While the convection heating system is operating, warm air is blown into the housing of the improved convection fan cover, where it is blocked by the top cover (not shown). As a result air is forced to move out of the convection fan cover via the openings (102).

However, rotation of the two arms results in the internal blocker (104), and to a lesser extent the counterbalance (105) periodically blocking the openings, causing disruptions in the air flow through the convection fan cover as air is allowed through some openings and not others. This forms an oscillating air profile in the oven cavity which helps to reduce or eliminate hotspots during convection. While in the preferred embodiment the counterbalance is smaller than the internal blocker, alternative embodiments allow for a counterbalance that is equal in physical size to the internal blocker to allow for varying air movement profiles.

Generally, the combined features of the improved convection fan cover result in a rotating airflow direction system which creates an even cooking profile.

As depicted, the cover consists of a circular cover punctuated with holes through which air escapes.

Internal blocker rotates, geared to fan shaft of the convection fan, rotation of internal blocker blocks certain holes as it rotates, blocking certain holes and allowing air through others. This forms an oscillating air profile in the oven cavity which helps to reduce or eliminate hotspots during convection.

While any oven-suitable material can be used in constructing the improved convection fan cover, materials suitable for high-temperature use are preferred, particularly materials that can sustain pyrolytic cleaning. Furthermore, the non-powered nature of the invention reduces costs necessary to insulate sensitive electronic components from damage during pyrolytic cleaning.

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

What is claimed is:

1. A convection oven, the convection oven comprising:
an oven body, the oven body defining a cooking cavity having at least one wall with an opening;
a convection heating system mounted to the oven body, the convection heating system having:
a heating element for heating air, and
a fan to blow the heated air into the cooking cavity through the opening;
a convection fan cover attached to the opening, the convection fan cover having a plurality of openings to allow heated air to move into the cooking cavity; and
an oscillation system attached to the convection fan cover, the oscillation system blocking at least one of the plurality of openings at alternating intervals.

2. The convection oven of claim 1, wherein the blocking of at least one of the plurality of openings modifies the movement of air through the convection fan cover and into the cooking cavity.

3. The convection oven of claim 1, wherein the plurality of openings comprise a series of uniform holes spaced at regular intervals

4. The convection oven of claim 1, wherein the convection fan cover has an inner surface facing the fan, and an outer surface facing the cooking cavity.

5. The convection oven of claim 4, wherein the convection fan cover is formed as a cylinder, the cylinder having a center line axis and a height.

6. The convection oven of claim 5, wherein the oscillation system comprises an internal blocker extending along a first radial direction from the center line axis to the inner surface, the internal blocker blocking at least one of the plurality of openings.

7. The convection oven of claim 6, wherein the oscillation system further comprises a counterbalance extending along a second radial direction opposite from the blocking member.

8. The convection oven of claim 6, wherein the oscillation system is rotated around the center line axis.

9. The convection oven of claim 6, wherein the oscillation system further comprises an axle extending away from the oven cavity towards the fan.

10. The convection oven of claim 9, wherein the axle is geared to the fan and rotation of the fan powers rotation of the axle.

11. The convection oven of claim 10, wherein rotation of the oscillation system occurs due to rotation of the axle.

12. A convection fan cover, the convection fan cover comprising:
a housing, the housing having a plurality of openings to allow for the movement of air out of the housing; and
an oscillation system disposed inside the housing, the oscillation system blocking at least one of the plurality of openings at alternating intervals to modify the movement of air out of the housing.

13. The convection fan cover of claim 10, wherein the plurality of openings comprise a series of uniform holes spaced at regular intervals to allow for the movement of air out of the housing.

14. The convection fan cover of claim 12, wherein the housing is in the form of a cylinder, the circle having a center line axis and a height.

15. The convection fan cover of claim 14, wherein the housing has an inner surface and an outer surface.

16. The convection fan cover of claim 15, wherein the oscillation system comprises a blocking member extending along a first radial direction from the center line axis to the inner surface, the internal blocker blocking at least one of the plurality of openings.

17. The convection fan cover of claim 16, wherein the oscillation system further comprises a counterbalance extending along a second radial direction opposite from the blocking member.

18. The convection fan cover of claim 16, wherein the oscillation system further comprises an axle and rotation of the axle translates to rotation of the of the blocking member.
